(19) United States
(12) Patent Application Publication
(10) Pub. No.: US 2005/0114755 A1
(43) Pub. Date: May 26, 2005

(54) Knowledge multiplier

(76) Inventors: James V. Leonard, St. Charles, MO (US); William J. Ebert, Kirkwood, MO (US); Richard E. Meyer, Florissant, MO (US)

Correspondence Address: BLACK LOWE & GRAHAM, PLLC, 701 FIFTH AVENUE, SUITE 4800, SEATTLE, WA, 98104, US

(21) Appl. No.: 10/722,073

(22) Filed: Nov. 25, 2003

(51) Int. Cl. G06F 17/24; G06F 17/21; G06F 17/00; G06F 15/00; G06F 17/30; G06F 7/00; G06F 17/60

(52) U.S. Cl. 715/501.1; 705/1; 715/500; 707/3

(57) ABSTRACT

Embodiments of the invention present a method, system and computer software program for augmenting an internal library with published submissions to a technical society. An abstract for a published submission is located on a technical society website. The abstract for the published submission is downloaded to a machine-readable memory medium at a first address. The published submission is located on a technical society website. The published submission is downloaded to the machine-readable memory medium at a second address. A hyperlink to the second address is embedded into the abstract. The hyperlink is configured to display the published submission when invoked.

### FIELD OF THE INVENTION

This invention relates generally to distributed networks and, more specifically, to developing web content.

### BACKGROUND OF THE INVENTION

Large industrial manufacturers foster technical affiliations to encourage intellectual cross-pollination. In fields such as aerospace and electronics, industry leaders seek to obtain and to provide guidance in setting standards for interfaces, communications linking, and hardware, to name a few areas where technical affiliations can pay big dividends. Technical affiliations might include affiliations with engineering societies as well as with universities, government, and the rest of industry.

One such technical affiliation is through the submission of papers to engineering societies. To promote uniformity both in within the manufacturer and across the industry, industrial manufacturers have supported the submission of papers describing good engineering solutions to engineering societies such as the Institute of Electrical and Electronics Engineers, Inc. (IEEE).

The IEEE is a non-profit, technical professional association of more than 380,000 individual members in 150 countries. Through its members, the IEEE is a leading authority in technical areas ranging from computer engineering, biomedical technology and telecommunications, to electric power, aerospace and consumer electronics, among others. Through its technical publishing, conferences and consensus-based standards activities, the IEEE produces 30 percent of the world's published literature in electrical engineering, computers and control technology, holds annually more than 300 major conferences, and has nearly 900 active standards with 700 under development.

Engineer employees of industrial manufacturers are often presenters at major conferences and contributors to the standards writing process through the IEEE. In many instances, the papers that engineer employees contribute may not be well-circulated even within the ranks of engineers the industrial manufacturer employs. An unintended consequence is that the industrial manufacturer may pay several engineers to invent work on the same problem in different programs and further, no standard solution results. Even if the industrial manufacturer does keep a good library of submissions by its own engineers, the industrial manufacturer must further encourage the engineers to look outside of library for solutions that exist in the industry that may be suitable for use by the industrial manufacturer.

The IEEE, on the other hand, keeps and indexes all of the papers and other submissions of its members for the purpose of enhancing the practice by the industry. With many of the societies, but with IEEE in particular, the whole of the indexed submissions are readily accessible by means of an active service page on the Internet. The industrial employer may download the submissions into an internal library kept for use by engineer employees.

There remains an unmet need, therefore, for a method, computer system, and software for augmenting the internal library with published society submissions making the submissions available to the engineer employees of the industrial employer without requiring additional research.

### SUMMARY OF THE INVENTION

The embodiments of the invention allow a greater dissemination of papers presented to technical societies. By assuring the availability of presented papers, employers of presenters can leverage the information well beyond those who attend the presentation but to others with similar interests within the employer's organization.

The embodiments of the invention allows rapid accumulating, abstracting, and indexing of important presentations to technical societies by exploiting the society's publication of the abstracts and presentation materials. By using abstracts and papers already published by the technical society, the employer can quickly accumulate an extensive catalogue of employees' presentations without duplicating the technical society's efforts in indexing the abstracts and presentations.

Embodiments of the invention present a method, system and computer software program for augmenting an internal library with published submissions to a technical society. An abstract for a published submission is located on a technical society website. The abstract for the published submission is downloaded to a machine-readable memory medium at a first address. The published submission is located on a technical society website. The published submission is downloaded to the machine-readable memory medium at a second address. A hyperlink to the second address is embedded into the abstract. The hyperlink is configured to display the published submission when invoked.

### BRIEF DESCRIPTION OF THE DRAWINGS

The preferred and alternative embodiments of the present invention are described in detail below with reference to the following drawings.

FIG. 1 is a schematic diagram of a computer;

FIG. 2 is a flowchart of a method for submission of a paper to a society; and

FIG. 3 is a flowchart of a method for augmenting a library with a published paper.

### DETAILED DESCRIPTION OF THE INVENTION

By way of overview, embodiments of the invention present a method, system and computer software program for augmenting an internal library with published submissions to a technical society. An abstract for a published submission is located on a technical society website. The abstract for the published submission is downloaded to a machine-readable memory medium at a first address. The published submission is located on a technical society website. The published submission is downloaded to the machine-readable memory medium at a second address. A hyperlink to the second address is embedded into the abstract. The hyperlink is configured to display the published submission when invoked.

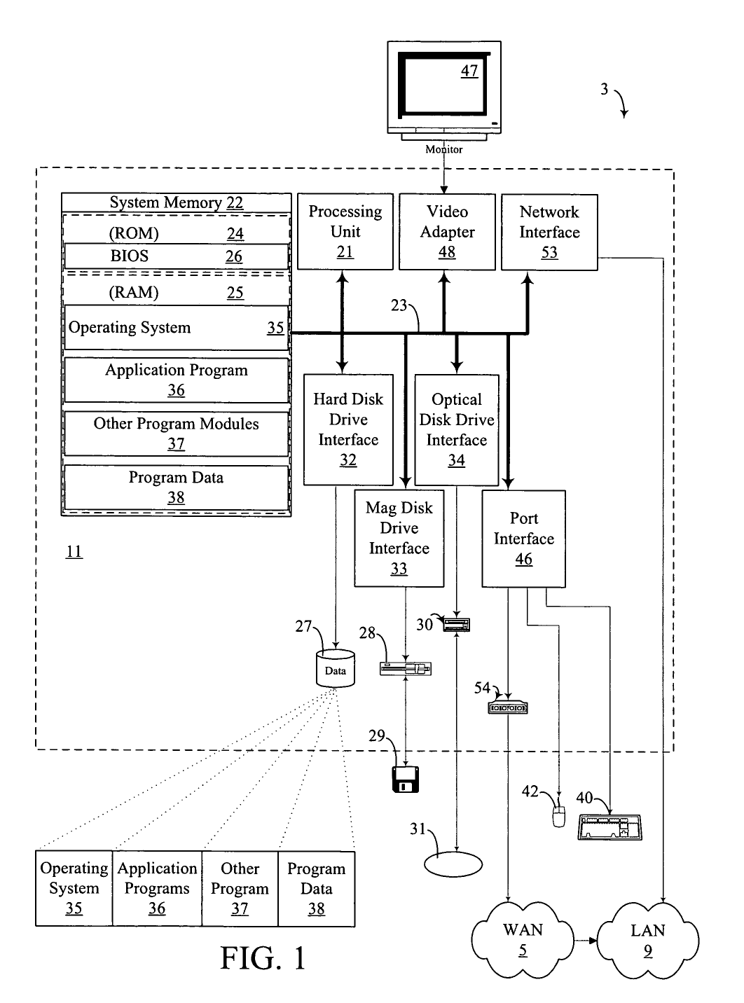

Referring to FIG. 1, an exemplary computing system 3 for implementing the invention includes a computer 11 having a processing unit 21, a system memory 22, and a system bus 23 that couples the system memory 22 to the processing unit 21. The system memory 22 includes read-only memory (ROM) 24 and random access memory (RAM) 25.

A basic input/output system 26 (BIOS), containing basic routines that help to transfer information between elements with the computer 11 such as during startup is stored in ROM 24. The computer 11 further includes a hard disk drive 27, a magnetic disk drive 28, e.g. to read from or write to a removable disk drive 29, an optical disk drive 30, a CD-ROM disk 31, or to read from or write to other media. The hard disk drive 27, the magnetic disk drive 28, and an optical disk drive 30 are connected to the system bus 23 by a hard disk drive interface 32, a magnetic disk drive interface 33, and an optical disk drive interface 34, respectively. The drives and their associated computer-readable media provide non-volatile storage for the computer 11. Although the description of computer-readable media above refers to a hard disk, a removable magnetic disk, and a CD-ROM disk, it should be appreciated by those skilled in the art that other types of media which are readable by a computer, such as magnetic cassettes, flash memory cards, digital video disks, Bernoulli cartridges, and the like, may also be used in the exemplary operating environment.

A number of program modules may be stored in the drives and RAM 25, including an operating system 35, one or more application programs, such as an email program module 36, other program modules, such as the message manager program module 37, a local message store 38, and a database 39 for supporting email applications. A user may enter commands and information into the computer 11 through a keyboard 40 and a pointing device, such as a mouse 42. Other input devices (not shown) may include a pen, a touch operated device, a microphone, a joystick, a game pad, a satellite dish, a scanner, or the like. These and other input devices are often connected to the processing unit 21 through a port interface 46 that is coupled to the system bus, but may be connected by other interfaces, such as a serial port, a game port, or a universal serial bus (USB). A monitor 47 or other type of display device is also connected to the system bus 23 via an interface, such as the Video Doctor 48. In addition to the monitor, personal computers typically include other peripheral output devices (not shown), such as speakers or printers.

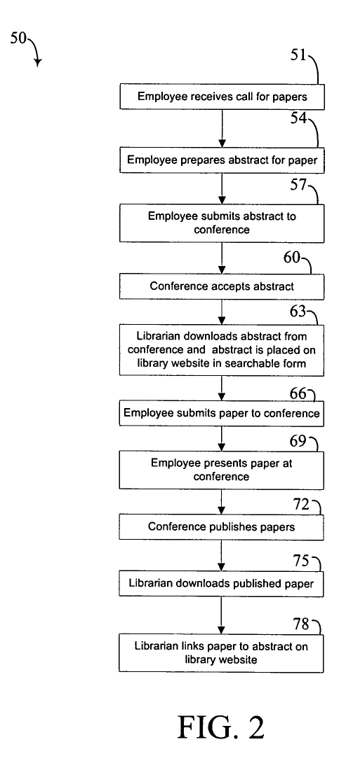

The computer 11 operates typically in a networked environment using logical connections to one or more remote computers, such as the remote computer 49. The remote computer 49 may be an email server (which includes one or more message stores), as described above in connection with FIG. 1. A file server (which includes one or more files stores), a router, a peer device or other common network note, and typically includes many or all of the elements described relative to the computer 11. The logical connections depicted in FIG. 2 include the local area network (LAN) or the wide area network (WAN) 5. Such networking environments are commonplace in offices, enterprise wide computer networks, intranets, and the Internet. When used in a LAN networking environment, the computer 11 is connected to the LAN 9 through a network interface 53 or additionally through the WAN 5. When used in an a WAN networking environment, the computer 11 typically includes a modem 54 or other means for establishing communications over the WAN 5 such as the Internet. The modem 54 which may be internal or external is connected to the system bus 23 via the serial port interface 46.

The invention may also be practiced in distributed computing environments where tasks are performed by remote processing devices that are linked through a communications network. In a distributed computing environment, the program modules may be located in both local and remote memory storage devices. Execution of the program modules may occur locally in a stand-alone manner or remotely in a client/server manner. Examples of such distributed computing environments include local area networks of an office, enterprise wide computer networks, and the Internet. In a networked environment, the program modules depicted relative to the computer 11, or portions thereof, may be stored in the remote memory storage device. It will be appreciated that the network connections shown are exemplary in other means of establishing a communications link between the computers may be used.

Referring now to FIG. 2 a method 50 for submission of a paper to a society according to a presently preferred embodiment begins at a block 51 when an engineer employee receives a call for papers from a technical society. Such calls for papers allow a conference of the technical societies to present the most recent developments in the field of study affiliated with the technical society.

At a block 54, an employee interested in nominating work for presentation prepares an abstract. Such abstracts are a regular means for societies to narrow the large number of submissions to those their membership will find interesting and appropriate. Abstracts allow societies to commit their resources to a reasonable number of authors without requiring each potential author to write the whole of a submission merely on the hope of publication.

At a block 57, the interested employee submits the abstract for review by the conference of the technical society. Generally the employer participates in production of the abstract by reviewing the abstract for technical worth, nondisclosure of trade or other secrets, and public relations value. The involvement of the employer may, advantageously, include docketing to review any publication of the abstract or a presentation the abstract describes.

At a block 60, the technical society informs the employee that the abstract is accepted after the technical society reads abstracts submitted and winnows the abstracts down in conference. Part of the informing includes the demand that the employee prepare a paper according to the abstract for submission. As a part of the acceptance, the technical society will publish the abstract.

Upon publication, a librarian from the employer locates and downloads the abstract at a block 63. Generally, the librarian will be able to download the abstract from a website on which the technical society has published the abstract. In some instances, the abstract has already been supplied to the librarian as a part of the employers' involvement submitting the abstract at the block 57. In either regard, the librarian will save text in a form suitable for publication on a website internal to the employer, indexing the text for search engines, making the abstract available to other engineer employees of the employer alerting the engineer employees of subject matter that may interest them in their work for the employer.

At a block 66, the engineer employee submits the paper the abstract describes to the technical society. Generally as a part of submission, the technical society edits and begins a dialogue to conform the paper to the needs of the technical society. When the paper is suitable, the technical society accepts it completing the submission and slates the paper for presentation to the technical society according to the technical society's schedule for presentation.

At a block 69, the employee presents the paper in accord with the ordinary procedure of the technical society. The presentation of the paper is not a necessary part of the method but is generally part of the submission process.

At a block 72, the technical society publishes the paper on its website, generally subsequent to the employee's oral presentation of the paper, though not necessarily so.

At a block 75, after publication, the librarian will download the paper off of the technical society website and store it in a searchable location on the website internal to the employer. Like the abstract, the purpose of storing the paper is to place the paper within the reach of the other engineer employees of the employer.

At a block 78, the librarian embeds a hyperlink in the abstract to provide a display of the paper upon activation of the hyperlink. Thus, unlike an entry in a card catalog in a library, the abstract itself is recalls the paper to the attention of a researcher seeking information on a topic. Advantageously, the abstracting and presenting of the paper is accomplished without requiring separate composition of research aids.

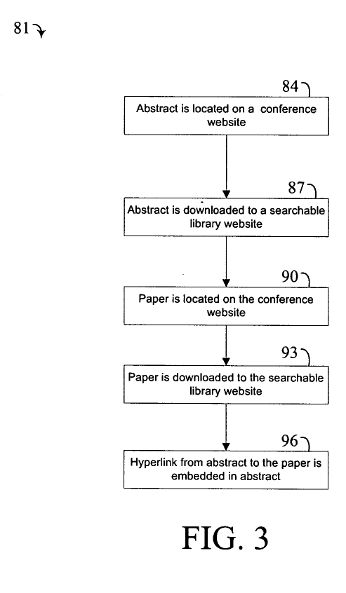

Referring now to FIG. 3 a method 81 augments a library with a published paper. Where an abstract and a paper reside on a technical society website, the process of augmenting an employer's library is readily accomplished either manually or by automated process.

At a block 84, an abstract of interest is located on the technical society website. Such abstracts need not be recent so long as they describe papers available for download. For instance, where the abstract and the paper both exist on the website, a first program script might be used to locate writings by engineer employees of the employer.

Upon locating an abstract of interest, at a block 87, the abstract is downloaded and saved to a first searchable library website. Again, this might be alternatively accomplished manually or by automated means.

Once the abstract of interest is located, the paper the abstract describes is located at a block 90. Generally, some indicia of the location of the paper will be found where the abstract is located in the form of a URL address or a hyperlink. Such indicia are generally placed at a website according to a standard definition and as such are readily susceptible to discernment by a second program script.

At a block 93, the paper is downloaded according to the location of the paper on the technical society website. The paper, like the abstract, is saved to a second searchable library website. An address of the second searchable library website is noted.

At a block 96, a hyperlink directing a browser to the second searchable library website upon activation of the hyperlink is formed and embedded in the abstract saved at the first searchable library website. Often this hyperlink will take the place of the indicia of the location of the paper as the abstract appeared on the technical society's website. Alternatively, the hyperlink might be added to the abstract at the first searchable library website.

While the preferred embodiment of the invention has been illustrated and described, as noted above, many changes can be made without departing from the spirit and scope of the invention. Accordingly, the scope of the invention is not limited by the disclosure of the preferred embodiment. Instead, the invention should be determined entirely by reference to the claims that follow.

1. A method for augmenting an internal library with published submissions to a technical society, the method comprising:
locating an abstract for a published submission on a technical society website;
downloading the abstract for the published submission to a machine-readable memory medium at a first address;
locating the published submission on a technical society website;
downloading the published submission to the machine-readable memory medium at a second address; and
embedding a hyperlink to the second address into the abstract, the hyperlink being configured to display the published submission when invoked.

2. The method of claim 1, wherein locating the abstract is based upon a submission approval procedure internal to an organization.

3. The method of claim 2, wherein locating the submission is based upon a submission approval procedure internal to an organization.

4. The method of claim 1, wherein the downloading of the abstract includes indexing the first address to allow searching for the abstract.

5. The method of claim 4, wherein the searching is by keyword.

6. The method of claim 4, wherein the searching is by subject.

7. The method of claim 4, wherein the searching is by author.

8. A computer software program for augmenting an internal library with published submissions to a technical society, the computer software program stored on a machine-readable memory medium and comprising:
a first software component for locating an abstract for a published submission on a technical society website;
a second software component for downloading the abstract for the published submission to the machine-readable memory medium at a first address;
a third software component for locating the published submission on a technical society website;
a fourth software component for downloading the published submission to the machine-readable memory medium at a second address; and
a fifth software component for embedding a hyperlink to the second address into the abstract, the hyperlink being configured to display the published submission when invoked.

9. The computer software program of claim 8, wherein locating the abstract is based upon a submission approval procedure internal to an organization.

10. The computer software program of claim 9, wherein locating the submission is based upon a submission approval procedure internal to an organization.

11. The computer software program of claim 8, wherein the downloading of the abstract includes indexing the first address to allow searching for the abstract.

12. The computer software program of claim 11, wherein the searching is by keyword.

13. The computer software program of claim 11, wherein the searching is by subject.

14. The method of claim 11, wherein the searching is by author.

15. A system for augmenting an internal library with published submissions to a technical society, the method comprising:
a first means for locating an abstract for a published submission on a technical society website;
a second means for downloading the abstract for the published submission to a machine-readable memory medium at a first address;
a third means for locating the published submission on a technical society website;
a fourth means for downloading the published submission to the machine-readable memory medium at a second address; and
a fifth means for embedding a hyperlink to the second address into the abstract, the hyperlink being configured to display the published submission when invoked.

16. The system of claim 15, wherein locating the abstract is based upon a submission approval procedure internal to an organization.

17. The system of claim 16, wherein locating the submission is based upon a submission approval procedure internal to an organization.

18. The system of claim 15, wherein the downloading of the abstract includes indexing the first address to allow searching for the abstract.

19. The system of claim 18, wherein the searching is by keyword.

20. The system of claim 18, wherein the searching is by subject.

21. The system of claim 18, wherein the searching is by author.
